(19) United States
(12) Patent Application Publication
(10) Pub. No.: US 2019/0176258 A1
(43) Pub. Date: Jun. 13, 2019

(54) Apparatus and Method for Wireless Emergency Shutdown of Current Through Welding Cable Leads

(71) Applicant: Lindsey M. Fontenot, Gray, LA (US)

(72) Inventor: Lindsey M. Fontenot, Gray, LA (US)

(21) Appl. No.: 16/212,905

(22) Filed: Dec. 7, 2018

Related U.S. Application Data
(60) Provisional application No. 62/595,821, filed on Dec. 7, 2017.

(51) Int. Cl. B23K 9/10; B23K 9/32

(52) U.S. Cl. CPC B23K 9/1087; B23K 9/321; B23K 9/10

(57) ABSTRACT

Apparatus and method for remotely controlling the flow of current to a welding rod electrode so that the electric arc between the welding wire electrode and a workpiece may be immediately interrupted and welding instantly stopped is disclosed. The apparatus includes remotely controlled switchgear positioned between welding wire cable leads attached to welding rod electrode holder of a welding machine. The switchgear is coupled to a wireless receiver for receiving wireless control signal from a remote wireless transmitter to trigger the opening of a welding cable lead disconnect switch. The apparatus includes an audible alarm to alert welders of the shutdown electrical current and a potentially dangerous situation.

### PRIORITY

This application claims priority to U.S. Provisional Application Ser. No. 62/595,821 filed Dec. 7, 2017 for “Apparatus and Method for Wireless Emergency Shutdown of Current through Welding Cable Leads”, the entire content of which is incorporated by reference.

### FIELD OF THE INVENTION

This invention relates generally to the field of industrial welding and more particularly relates to a method and apparatus for shutting down the flow of electrical current to welding equipment in the event of fire or other safety hazard.

### BACKGROUND OF THE INVENTION

Industrial welding typically is done by providing a welding machine that provides electric current through a cable lead from the welding machine to a welding rod electrode that is attached to a welding rod holder. The current running through the welding rod electrode must be sufficient to create an electric arc and heat sufficient to melt the welding rod electrode and adjacent metal workpieces in order to the workpieces together to complete a weld. The electric arc and heat produced during welding operations necessarily produces flames and flying sparks. Welding and the use of welding equipment at settings where pressurized natural gas, hydrocarbons and flammable chemicals may be present, such as at oil & gas facilities, chemical processing and manufacturing plants, and other industrial facilities where flammable gases are present, increases the risk of fire and explosion due to the extreme heat, sparks, and flames inherent in the welding process. Consequently, welding and the use of welding equipment, which is often referred to as “Hot Work”, at such locations becomes a hazardous and high risk activity. Nevertheless, Hot Work at such locations is often a necessary activity in order to maintain the facilities and repair process equipment.

In most cases, such maintenance and repair involves only a small segment or area of a facility. When Hot Work is required or necessary to maintain or repair equipment and facilities, that small segment or area of the facility where the Hot Work is to be performed is isolated and made “Fire Safe.” An area is typically made Fire Safe by hanging fire proof tarps to isolate and contain sparks and debris, shielding nearby flammable tanks, pressure vessels, piping containing flammable substances, removing combustible materials such as wood, paper, and rope from the area, positioning and maintaining fire extinguishers and firehose reels in the immediate area in a state of readiness for instant use. Even when an area is made Fire Safe there is still a risk that pressurized flammable gasses or flammable chemicals have remained in or will migrate to the Fire Safe area. Consequently, a Fire Safe area must be constantly monitored to assure that there has been no leak, migration, or accidental release of flammable gasses or flammable chemicals.

Whenever welding or cutting is performed in locations where other than a minor fire might develop, Fire Watchers, as specified in the US Department of Labor OSHA Standards, 29 CFR Part 1910.252(a)(2)(iii), are required to monitor conditions during the welding process and for a thirty minute period after the welding is completed. Fire Watchers are responsible for verifying that all the conditions necessary to make a specific area Fire Safe have been performed, becoming familiar with the equipment necessary to sound an alarm, maintaining visual contact with the person welding and with the Hot Work area, and alerting the welder of unintended flames, and for calling for welding to stop when an undesirable event occurs such as loss of containment of nearby pressurized flammable liquids of gases. Hot Work in the Fire Safe area may not be resumed until the Hot Work is restored to a safe condition.

A problem associated with the use of a Fire Safe area and a Fire Watcher is the ability to insure that welding and other Hot Work is immediately discontinued in the event of a hazardous condition or another undesirable situation. If hazardous gases or chemicals cannot be contained or if there is a sudden leak or extravasation of such gasses or chemicals or other such emergency condition occurs, a welder with a welding hat and shield pulled down may not hear a verbal command from Fire Watcher to stop welding and shut down the welding equipment. Even if a welder does stop welding upon command, other workers exiting the area may accidently contact or strike a welding lead causing unintended or accidental sparks. Such sparks could ignite a fire or cause an explosion creating disastrous results in the presence of a flammable gas or liquid. In some situations a welder may be incapacitated and unable to remove a welding rod from the welding rod holder at the end of the welding lead or, in an emergency situation, may not think to do so.

Consequently, a need exists to for a device to allow a Fire Watcher or other nearby personnel to remotely control the flow of current to the welding rod electrode so that the electric are between the welding wire electrode and the workpiece may be immediately interrupted and welding instantly stopped in the event of a hazardous or emergency situation.

### SUMMARY OF THE INVENTION

The present invention provides an apparatus and method for wireless emergency shutdown of current to a welding rod electrode designed to satisfy the aforementioned needs. The apparatus includes switchgear positioned between one or more welding cable leads from a welding machine a welding rod electrode attached in a welding rod holder. The switchgear has fuses or circuit breakers, transformers, and a welding cable lead disconnect switch which when opened is used to immediately shut down electrical current to the welding rod electrodes. The switchgear is coupled to a wireless receiver for receiving a wireless control signal from a wireless transmitter to trigger the opening and closing of the welding cable lead disconnect switch. The wireless receiver may be powered by wiring from the welding machine.

The apparatus may also include visual and audible alarms that may be activated by the wireless transmitter. The apparatus includes a switchgear housing for the switchgear and the wireless receiver. The housing may include an audible alarm and a display with signal lights indicating status of the current provided by the welding machine to the welding rod electrode. The display signal lights may show when electrical power is available from the welding machine, when electrical power is provided to the welding rod electrode, and when electrical power to the welding rod electrode is shut down. It is thought that the wireless control signals between the wireless receiver and wireless remoter transmitter will be FM radio signals but other types of wireless control signals may be utilized. The wireless transmitter is certified intrinsically safe, NFPA Class I, Division 1, for use all classified hazardous areas.

To use the apparatus and system described herein, a Firewatcher will be in possession of the wireless transmitter at all times when on duty. If an undesirable event occurs such as loss of containment of nearby pressurized flammable liquids of gases or in the event that a fire breaks out, the Firewatcher can then use the remote wireless transmitter to activate the welding cable lead disconnect switch and immediately interrupt and stop the flow of electric current through the attached welding cable leads to the weld rod electrode.

### DESCRIPTION OF THE DRAWINGS

FIG. 1 is a schematic view of the method and apparatus for wireless emergency shutdown of current to welding cable leads in accordance with the description set forth herein.

FIG. 2 is a schematic of the switchgear and electrical components of the apparatus for wireless emergency shutdown of current to welding cable leads shown in FIG. 1.

FIG. 3 is a schematic view of the switchgear housing and signal display of the apparatus shown in FIG. 1.

FIG. 4 is a schematic view of the remote transmitter of the apparatus shown in FIG. 1.

### DESCRIPTION OF THE EMBODIMENT

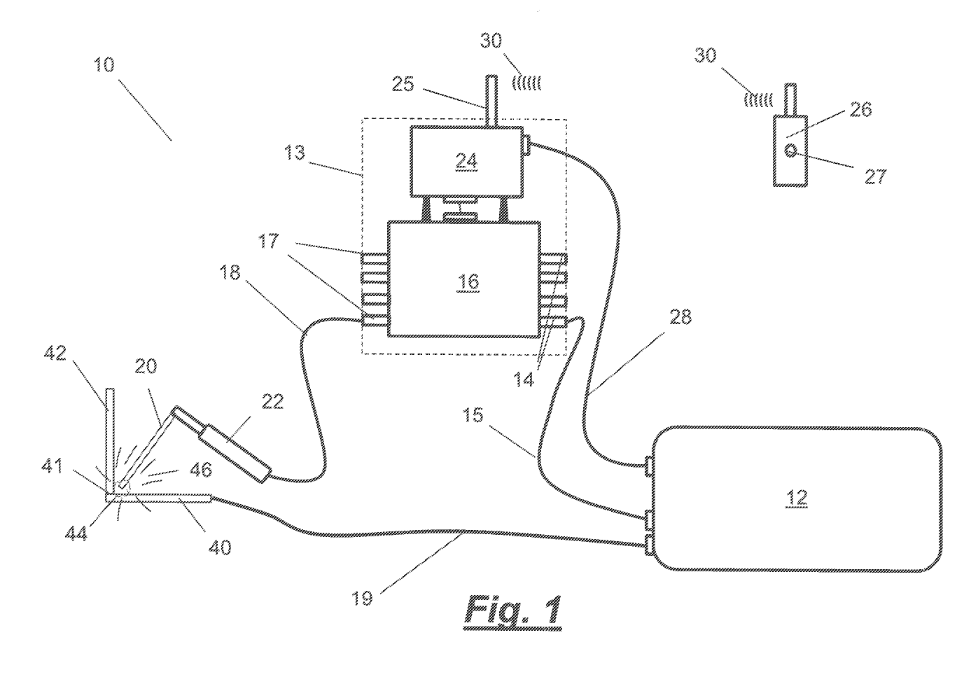

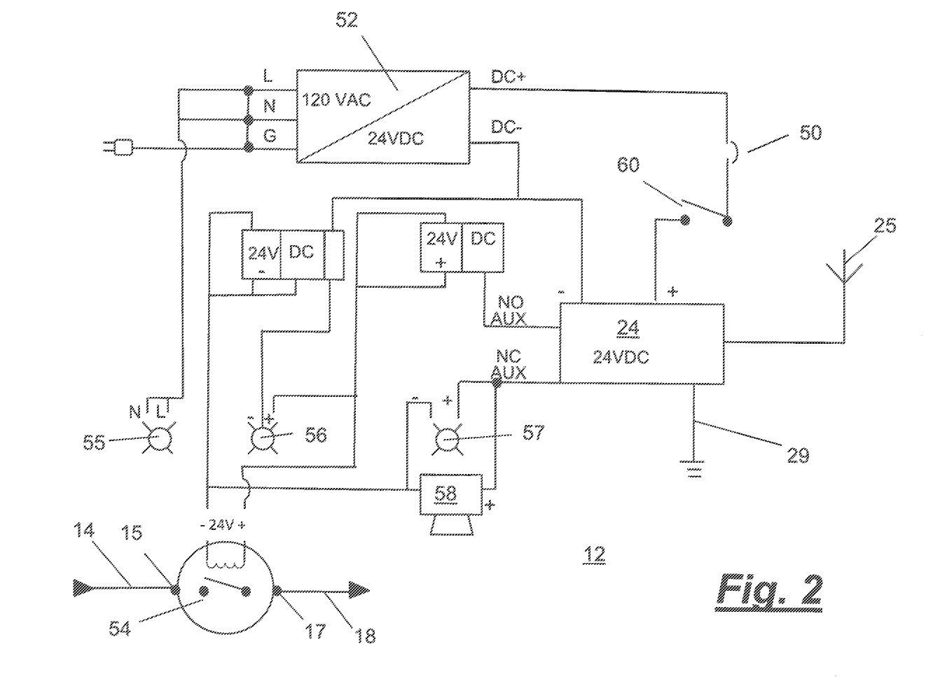

Referring to the drawings, FIG. 1 shows a schematic view of the apparatus 10 and the method for wireless emergency shutdown of current to a welding rod electrode. Apparatus 10 is comprised of welding machine 12 providing current to a first welding cable lead 15, a remotely controlled switchgear 16 as shown in FIG. 2, a second welding cable lead 18 attached to welding rod electrode 20, a welding rod electrode holder 22, and a grounding cable 19.

Remotely controlled switchgear 16 is mounted in switchgear housing 13 and includes input terminal block 14 for attachment of a first welding cable lead 15 extending from the welding machine 12 and an output terminal block 17 for attachment to second welding cable lead 18. Switchgear 16 has welding cable lead disconnect switch 54 that is remotely controlled by a portable wireless receiver 24 with antenna 25 and wireless transmitter 26.

Wireless receiver 24 is configured to receive control signals 30 transmitted by wireless transmitter 26 to open and close welding cable lead disconnect switch 54. Wireless receiver 24 is powered by a power supply line 28 from welding machine 12 but may also be battery powered. Preferably welding machine 12 will supply operating power to wireless receiver 24. Preferably the operating power from the welding machine 12 to wireless receiver 24 will be 120 VAC. Preferably wireless control signals 30 will be FM radio control signals but other types of wireless control signals may be utilized such as Bluetooth, Wi-Fi, ZigBee, or IF signals.

The wireless transmitter 26 will be of a type suitable for use in a Class I, Division 1 hazardous location as defined by the National Fire Protection Association (NFPA) Publication 70, National Electric Code® (NEC) in Articles 500 to 506 classification system. Such an environment includes: (1) locations were ignitable concentrations of flammable gases or vapors may exist under normal operating conditions; (2) ignitable concentrations of such gases or vapors may exist frequently because of repair or maintenance operations or because of leakage, and (3) breakdown or faulty operation of equipment or processes might release ignitable concentrations of flammable gases or vapors, and might also cause simultaneous failure of electric equipment.

Wireless receiver 24 need not necessarily be of a type suitable for use in a Class I, Division 1 hazardous location. In most case, switchgear housing 13 with switchgear 16 and wireless receiver 24 will be mounted on an instrumentation stand typically located in an unclassified area near welding machines set up for work. Welding leads, most often 100 feet or more in length, would connect to switchgear 16 in the unclassified area and run through Class 1 Division 1 areas, to a Class 1 Division 1 area made safe for Hot Work. However, switchgear housing 13 may be an explosion proof enclosure with switchgear 16 and wireless receiver 24 mounted inside if desired.

As shown in FIG. 1, when welding operations, i.e. Hot Work, are being performed and apparatus 10 is in use, welding cable lead disconnect switch 54 of switchgear 16 is placed in a closed position and grounding cable 19, extending from welding machine 12, is attached to a first workpiece 40 that is adjacent to a second workpiece 42. Welding rod electrode 20 on welding rod electrode holder 22 is the placed in proximity to the junction 41 of the first workpiece 40 and the second workpiece 42 and sufficient electric current is generated by welding machine 12 and transmitted through welding cable lead 15 and welding cable lead 18 to welding electrode 20 to create an electric arc 44. Heat generated by electric arc 44 will have accompanying sparks and flames 46 and is sufficient to melt welding rod electrode 20 and a portion of the first workpiece 40 and a portion of the second workpiece 42 in order to fuse the first workpiece 40 and the second workpiece 42 together to complete a weld.

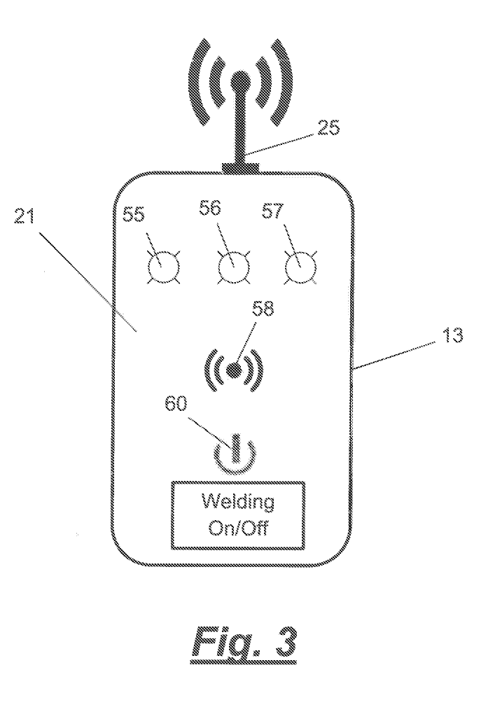

As shown in FIGS. 2 and 3, switchgear 16 has fuses or circuit breakers 50, a transformer and rectifier 52, and an on/off button 60 for shutting down the power from the welding machine 12. The transformer and rectifier 52 change the voltage from 120 VAC to 24 VDC. Switchgear 16 also includes the welding cable lead disconnect switch 54 which when opened is used to immediately shut down electrical current from welding machine 12 to welding cable lead 18 and to welding rod electrode 20. Switchgear 16 is coupled to wireless receiver 24 for receiving wireless control signals 30 from wireless transmitter 26 to trigger the opening and closing of welding cable lead disconnect switch 54. Wireless receiver 24 may be powered by power supply line 28 from welding machine 12 through transformer and rectifier 52. Wireless receiver 24 may be grounded by a ground 29.

The apparatus 10 may include a display of signal lights 21 on the switchgear housing 13 indicating the status of the electric current provided by the welding machine 12. Such display of signal lights 21 may include individual colored signal lights indicating that electric power is being generated from the welding machine, such as a blue light 55, a signal light indicating when electrical power is provided to the welding rod electrode 20, such as a green light 56, and a signal light indicating when electrical power to the welding rod electrode 20 is shut down, such as a red light 57. The apparatus 10 may also include an audible alarm 58 mounted with switchgear 16 and switchgear housing 13 triggered by the closing of the welding cable lead disconnect switch 54 for alerting personnel of a hazardous condition in the work area and the shutdown of current from the welding machine 12.

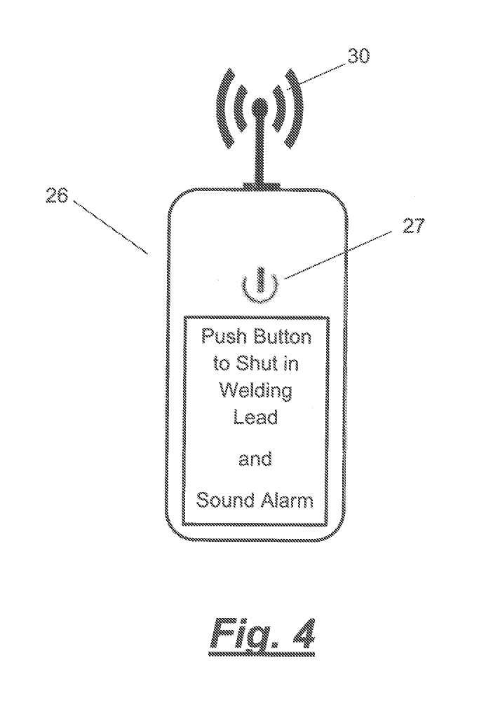

Remote wireless transmitter 26 shown in FIG. 4 has a control button 27 and transmitter 26 may be carried or worn by a Firewatcher and carried to a position remote from the welding operation being performed. If an undesirable event occurs during the welding operations, such as an extravasation of flammable liquids of gases into an area where welding is being performed, remotely located wireless transmitter 26 may be used remotely by a Firewatcher or other personnel by pushing control button 27 to generate control signals 30 to wireless receiver 24 to open welding cable lead disconnect switch 54 of switchgear 16. Opening welding cable lead disconnect switch 54 will immediately interrupt and cease electric current flow to welding rod electrode holder 22 and welding rod electrode 20 from welding machine 12 and suppress or eliminate the electric arc 44 between welding rod electrode 20 and workpiece 40 and workpiece 42 and stop the welding process.

The electrical switchgear 13 of apparatus 10 may be provided with pluralities of input terminal blocks 14 and output terminal blocks 17 for connection of welding cable leads 15 and 18 from additional welding machines 12. This would allow the control of current flow to additional to welding rod electrode holders 22 and their associated welding rod electrodes 20 when more than one welder is working.

In industrial facilities such as chemical plants, refineries, oil and gas drilling rigs, and the like, personnel are trained to notice the location of emergency and lifesaving equipment immediately upon their arrival at such facilities. The visual appeal of apparatus 10 will its housing 13, handheld transmitter 26 and lighted display 21 provides such personnel with a heightened level of comfort knowing that a Firewatcher has access to an immediate safely shutdown of Hot Work. Such heightened or enhanced level of comfort enables such personnel to focus their attention on immediate hazards associated with their assigned task and not worry as much about risks and hazards associated with extravasation or migration of flammable liquids or gasses into a work area.

The visual appeal and presence of the apparatus 10 provides the same effect and reassurance for workers as other emergency lifesaving equipment such as fire extinguishers, fire hoses, and escape capsules. Apparatus 10 may be utilized by workers, safety managers, and safety professionals when calculating a strategy to manage safety in a variety of work locations. The visual recognition of apparatus 10 may be referenced as a specific tool or safety device during pre-job safety meetings and can be included in step by step emergency response plans to control undesirable events.

It will be evident that various other changes may be made in the form, construction and arrangement of the parts and steps of the apparatus and method described herein without departing from the spirit, scope, and material advantages of the invention. It is also thought that the method and apparatus presented herein will be understood from the foregoing description and that the forms and steps described herein are intended to be merely exemplary embodiments of the invention.

I claim:

1. An apparatus for immediate interruption of a flow of current to a welding rod electrode comprising:
(a) a welding machine providing electric current through a welding cable lead and a welding rod electrode holder to a welding electrode;
(b) a remotely controlled welding cable lead disconnect switch whereby current through said welding cable lead may be interrupted;
(c) a wireless receiver whereby switch control signals to said welding cable lead disconnect switch may be generated; and
(d) a remote wireless transmitter whereby wireless control signals to said wireless receiver may be transmitted.

2. The apparatus recited in claim 1, further comprising an audible alarm triggered from said wireless transmitter.

3. The apparatus recited in claim 2, further comprising a display of signal lights.

4. The apparatus recited in claim 3 wherein said wireless control signals to said wireless receiver are radio signals.

5. The apparatus as recited in claim 4 wherein said wireless transmitter is incapable of causing ignition of a mixture of flammable or combustible material in air.

6. The apparatus as recited in claim 5 wherein said display of signal lights includes colored lights.

7. A method for immediate interruption of a flow of current through a welding cable lead to a welding rod electrode comprising the steps of:
(a) providing a welding machine, said welding machine including a first welding cable lead, a second welding cable lead attached to a welding rod electrode holder having an attached welding rod electrode, and a grounding cable;
(b) providing a remotely controlled switchgear, said remotely controlled switchgear including a welding cable lead disconnect switch positioned between said first welding cable lead and said second welding cable lead, whereby said welding cable lead disconnect switch may be opened or closed;
(c) providing a wireless receiver engaged with said remotely controlled switchgear whereby said welding cable lead disconnect switch may be opened from signals from said wireless receiver;
(d) providing a remote wireless transmitter whereby wireless control signals may be transmitted to said wireless receiver;
(e) providing a workpiece;
(f) attaching said grounding cable to said workpiece;
(g) closing said welding cable lead disconnect switch;
(h) generating electric current from said welding machine through said first welding cable lead, said second welding cable lead and said welding rod electrode holder to said welding rod electrode;
(i) placing said welding wire electrode at a position with respect to said workpiece and thereby creating an electric arc between said welding wire electrode and said workpiece; and
(j) generating said wireless control signals from said remote wireless transmitter to said wireless receiver whereby control signals are generated to said remotely controlled switchgear whereby said welding cable lead disconnect switch may be opened to interrupt electric current through said first and second welding cable leads.

8. The method recited in claim 7 comprising the additional steps of:
(a) providing an audible alarm; and
(b) triggering said audible upon said opening said welding cable lead disconnect switch.

9. The method recited in claim 8 comprising the additional step of using said remote wireless transmitter from a location remote from said workpiece.

10. An apparatus whereby a flow of current to a welding rod electrode may be immediately interrupted comprising:
(a) a welding machine for generating electric current, said welding machine including a first welding cable lead, a second welding cable lead, a welding rod electrode attached to said second welding cable lead, a welding rod electrode holder, and a grounding cable;
(b) a remotely controlled switchgear positioned in a switchgear housing, said remotely controlled switchgear including a welding cable lead disconnect switch positioned between said first welding cable lead and said second welding cable lead;
(c) a wireless receiver engaged with said remotely controlled switchgear whereby said welding cable lead disconnect switch may be opened;
(d) a remote wireless transmitter whereby control signals may be transmitted to said wireless receiver thereby opening said welding cable lead disconnect switch;
(e) an audible alarm sounding when said disconnect switch is opened; and

11. The apparatus recited in claim 10 wherein said wireless control signals are radio signals.

12. The apparatus as recited in claim 11 wherein said wireless transmitter is incapable of causing ignition of a mixture of flammable or combustible material in air.

13. The apparatus as recited in claim 12 further comprising a display of signal lights on said switchgear housing whereby the status of electric current generated by said welding machine is displayed.

14. The apparatus as recited in claim 13 wherein said display of signal lights includes colored lights.
